(19) United States
(12) Patent Application Publication
(10) Pub. No.: US 2003/0138536 A1
(43) Pub. Date: Jul. 24, 2003

(54) Method and apparatus for peeling of fruits cut in slides

(76) Inventor: Jan Staehr, Birkeroed (DK)

Correspondence Address: Hans H Haraldsten, Post Box 107, Farun, 3520, DK

(21) Appl. No.: 10/258,622

(22) PCT Filed: May 23, 2001
(86) PCT No.: PCT/DK01/00353

(30) Foreign Application Priority Data
Jun. 19, 2000 (DK) PA 2000 00933

(51) Int. Cl. A01J 1/00

(52) U.S. Cl. 426/518

(57) ABSTRACT

Method and apparatus (3 and 8) for peeling of garlic (1) and like vegetables as fruits (1). As the garlic (1) with “shells” (2) can be placed “loose” in a boiler (3), which generally for the purpose is close-able (6) and as an example for the purpose with a lit (6).

And where the garlic (1) then following are brought to an fast and momentary acceleration, and de-acceleration (4) by crashing against of the walls of the boiler (3) for momentary stop, and by this via a resulting big crash via its own weight. Namely by bringing the garlic (1) to crash against the sides of the walls of the boiler (3) and here of course especially the bottom (2) and the lit (6). Namely by that the boiler (3) for peeling with contents (1) has to be moved (4) fast up and down.

Or as alternative, that boiler is brought to swing (5) or rock (5) or like. And especially with such a pattern of movement, that the single garlic (1) continuous is forced round in the boiler (3) or the peeler (3) for stop and by this indirect stroke or crash against the inner of the surface of the boiler, and by this peeling the outer shells (2) off laid garlic (1).

The purpose with the present invention is to show a method as an example on an apparatus for automatically peeling of garlic and like vegetables as fruit.

Hitherto it is only known manually with a knife or other manually devices or means to try to take the outer shell of the single garlic unit, and which is taken out of its garlic- brunch, just short before the garlic itself shall be pressed or cut into pieces, or perhaps direct be used as hole by roasting or like.

The disadvantage by the earlier way to peel of a garlic is for the first, that it is difficult and time demanding, and the same time with, that one perhaps get the very large smell of the garlic on his or hers fingers.

By showing of the method and indicate an embodiment of an apparatus for peeling garlic after the method, then will one obtain to save a manually operation of working, when one as earlier said shall prepared a single garlic from a garlic brunch. As one now only shall split and take the single garlic from the brunch of garlic.

After the splitting, one only need, according to the invention, to laid the garlic down into the shown apparatus, and after this only to activate the mentioned apparatus.

The garlic will following now automatically be peeled.

And this without that one as earlier shall touch and manoeuvre with the fingers on the garlic, and under this normally rather difficult and time demanding operation.

And specially if there is more garlic there have to be peeled, which often there has to be.

The above mentioned advantages can be obtained according to the invention by a method, and an apparatus of this in the start mentioned sort, and characteristic of, that the garlic with “shells” only shall be placed “loose” or “free movable” in a boiler. Which boiler here ideally generally and for the purpose can be closed. And where the laid garlic then following can be brought to an fast and momentary acceleration and de-acceleration, and by this get momentary touch on the walls of the boiler, for a momentary stop of the movement of the garlic and change its direction of movement to the opposite.

By this momentary stop, the garlic get a resulting stroke or crash, and a peeling off of the outer shells, which just one want with the made operation.

This function is made via the own weight of the garlic itself, namely by the inertia there are in the moving garlic, when it has to be stop momentary of the walls or specified of the top or the bottom of the boiler.

The single garlic has to be brought by the method to forced collision against specially sides of the peeling boiler, namely the bottom and the lit.

And namely by that the boiler itself for peeling with contents, into a specified embodiment, would be brought to move fast up and down. Or as alternative to this pattern of movement, where the boiler with contents would be brought to fast to swing, rock or like from side to side, with a rather fast frequency.

One obtain with the method that the single garlic little by little automatically will get their outer shells loose. As the outer shells a last are got off from the garlic itself, and in such a way, that the garlic now as wanted got exposed its juicy leaves.

In a specially embodiment for the apparatus and according to the invention, then can an apparatus in a exact embodiment consist of a close-able boiler made as an example of a loose cylindrical boiler with a lit.

The loose boiler can now be brought to move fast vertically up and down by placing it in a belonging activating apparatus. And where this apparatus either can be driven automatically, as alternative manually.

The actually activating apparatus can have a design as an open cup or like arrangement, where the peeling boiler itself can fit in. And following can the closed peeling boiler be placed in this cup- arrangement, to obtain a forced movement up and down. And in the same time also a steering and holding of the loose and closed garlic-boiler with loose garlic placed in this.

One obtain by this and according to the boiler-arrangement itself, that this would be a practical made and designed unit.

And according to the cleaning and to the storage operation also would be independent of the activating unit. But as in the same time would be easy to handle and clean.

In another embodiment according to the invention, then can the activating arrangement be integrated in respectively the keeping boiler for garlic, as also in the holding and steering apparatus for this.

As an example in an ideally embodiment, where the boiler can be fitted with magnetic-able material or permanent magnets. And where opposite the activating arrangement could be supplied with electromagnets. And where then these driving arrangements further optimum could be grouted in, in such a way, that the boiler and the driving arrangements could appeared with smooth and unbroken easy clean-able surfaces.

One obtain by this, when two arrangements respectively the boiler with grouted magnets, and the activating arrangement made as a cup or a bowl with electromagnets or spool-arrangements integrated in, that then will an activating of the electromagnets for respectively drawn as pressure, course, that the loose or free placed boiler of garlic will be forced to move up and down in the activating arrangement. By which the garlic has to be stroke and crashed against the top and the bottom of the boiler.

With this arrangement one obtain also, that there do not will be any movable parts besides the loose placed garlic-boiler. Which so again is an advantage according to cleaning, servicing of the components itself

In another embodiment according to the invention, then could the system for vertical activating, with an up and down going pattern of movement alternative also be established, with an eccentric mechanism for respectively electrical driven. As alternative in another embodiment, for manually driven, via as an example a handle or like.

And here of course via eccentric movement with forward and backward going movement laid especially in vertically plan.

One obtain by this, an up and down going movement, with a simple mechanism. Which still perhaps in a variant could be variable in the stroke, and according to the nature of the fruit or the vegetables with shells like the garlic, which one want to peel.

One obtain by this a mechanism, which would be cheaper in manufacturing and very simple to work with.

In the same time one obtain, that it is rather easy to make clean, if this is the want. Besides that this mechanism also in the same time will fit for a manually drift.

In another embodiment according to the invention, then could the peeling apparatus consist of a close-able and especially vertically standing peeling boiler. Which in its inner and at the bottom has a loose or free strike-piston.

And where there, to the function, to the peeling boiler further belong an activating unit or a vessel.

And where the strike- piston ideally can content of a permanent magnet arrangement.

And in the same time with, that the activating unit or the vessel has a build in electrical magnet arrangement, there by function can force the strike or the raising piston continuous up and down for lift and in the same time strike of the laid garlic.

One obtain by this, that the hole peeling arrangement is gathered in one unit, where only the boiler as the loose or freely strike piston shall be cleaned.

Have the two units be fitted to each other, then would the strike piston be able to be made in such a way, that the upper side always will be free for shells.

As the stroke piston could be hollow, or there could be air under. And besides with so much space to the side that the shells could glide down under and into a shell- reservoir or like.

The upper side of the strike piston could also be arched upwards so that all loose shells have to be forced down under the arrangement.

The invention shall after this be explained nearer in the following and under reference to the drawing, where

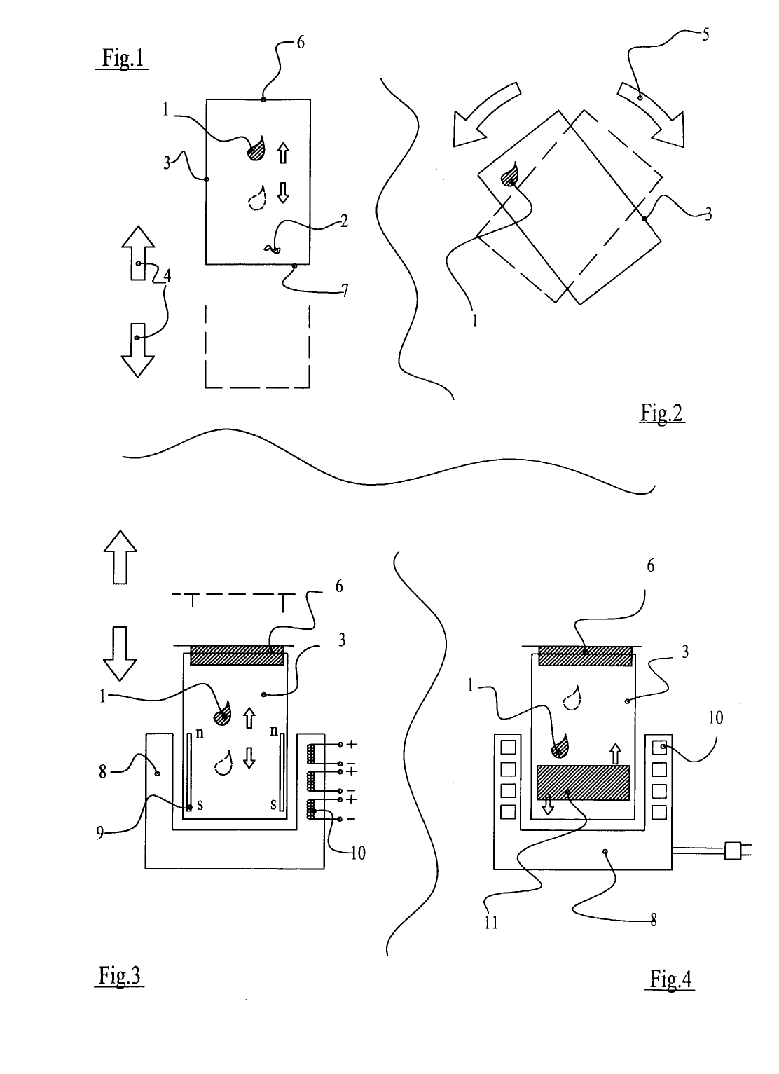

FIG. 1 shows a system-drawing of the method, where one has a closed boiler 3, which has to be activated fast up and down 4, and in such a way that the single laid garlic 1 or another like fruit or vegetables 1 by this, would be brought to strike especially against the bottom 7 and the top 6 of the boiler 3, and by which the outer shell 7 has to be loosen from the garlic 1.

FIG. 2 shows a system-drawing of the method, where one in fast frequency tip or turn 5 the boiler 3, and in such a way that the single garlic 1 now especially strike against the sides as the top 6 and the bottom 7 of the boiler 3, and by which the outer shell 2 on the garlic 1 has to be loosen.

The inner surface of the boiler 3 can of course be bettered, in such a way that the strike has to be bettered, and as an example by making the bottom 7 as the top 6 inward arched.

And perhaps as alternative, where one could placed a wire gauze with coarse size of mesh, and where this is lesser than the garlic 1 itself, but in the same time can allow the shell 2 itself to fall down under this.

One obtain by this, to get a larger point -or flat pressure, and perhaps an uneven divided pressure too, and in such a way that the shell 2 on the way get easier to loosen.

FIG. 3 shows an example on an embodiment of the invention, where a closed garlic boiler 3 has to be placed down into an activating vessel 8.

The activating vessel is here equipped with some electrical magnets 10 in sections, which have to be switched successive. And when these influence on the other magnet arrangement 9 there are in the boiler 3, then will the boiler lift as lower it self 3, and with that frequency one self have chosen.

FIG. 4 shows another example on an embodiment, where one inside the garlic boiler 3 has placed a loose placed piston 11, which in its inner has integrated as an example permanent magnets. And where guiding and activating vessel 8 itself is equipped with an arrangement of electric magnets 10, which can be activated as de-activated. And by which the piston 11 has to be moved up and down for strike against the single garlic 1.

1. Method for peeling of garlic (1) and like vegetables as fruits (1), characteristic of, that the garlic (1) with “shell” (2) has to be placed “loose” in a separate boiler (3), which here for the purpose can be close-able (6 and 7), and where the garlic (1) then following can be brought to a rather large acceleration, and de-acceleration (4) and by this to be brought to touch and crash against the walls (6 and 7) of the boiler (1) for momentary stop, namely by crashing against primary the sides of the walls of the boiler (3) as specially the bottom (7) and the lit (6), namely by that the boiler (3) for peeling with contents (1) has be brought to move (4) vertically up and down, or as alternative of movement, that the boiler has to be brought to swing or rock or like (5), and especially with such a pattern of movement, that the single garlic (1) continuous is forced round in the boiler (3) or the peeler (3) for stop and by this indirect strike against the inner of the surface of the boiler.

2. Automatically peeling apparatus for especially garlic (1) and like vegetables as fruits (1) with partly loose or loose -able shells (2) according to claim 1, characteristic of, that the apparatus in a specific embodiment can consist of a close-able boiler (3) made as an example of a loose or separate cylindrical boiler (3) or like, and with lit (6) and a bottom (7), and where the boiler (3) can be brought to move fast vertical up and down (4), as an example for the purpose by placing into a belonging activating apparatus (8) , which either can be driven automatic (10) or alternative manually, and where this activating apparatus (10) ideally could have a form, as an open cup (8) or an arrangement, where the peeling boiler (3) can be placed in, for a forced movement (4) up and down, and with this also an indirect and in the same time guiding and holding function.

3. Automatically peeling apparatus (3 and 8) for especially garlic (1) and like vegetables as fruits (1) with partly loose or loose -able shells (2) according to claim 1 and 2, characteristic of, that the activating or peeling arrangement (9, 10 and 11) can be integrated in respectively the holding boiler (3), as in holding and steering apparatus (8) for this (3), as in an embodiment, where the boiler (3) can be supplied with magnetic-able material or permanent magnets (9), and where opposite for the purpose the activating arrangement (10) is supplied with electromagnets (10), and where this driving arrangements ( 10) ideally for the purpose can be cast in, such as the boiler (3) as the driving arrangement (8 and 10) then now can be with smooth and easy clean-able surfaces.

4. Automatically peeling apparatus (3 and 10) for especially garlic (1) and like vegetables as fruits (1) with partly loose or loose -able shells (2) according to claim 2, characteristic of, that the system (3, 8, 9 and 10) for a vertical activating (4), and with a for- and back-going pattern of movement (4), alternative also can be establish for this purpose, with an eccentric mechanism of movement for respectively ideally electrical drift (10) with an electric-motor, as alternative for manually drift via a handle or like, and via an eccentric forward -and backward movement laid especially in vertically plan.

5. Automatically peeling apparatus (3 and 10) for especially garlic (1) and like vegetables as fruits (1) with partly loose or loos-able shells (2) according to claim 1, characteristic of, that the peeling apparatus (3 and 8) consist of a close-able, and especially a vertically standing peeling boiler (3), which in its (3) inner has a “loose” crashing piston (11), and where there to the function of peeling boiler (3) further belong an activating vessel (8), and where the crashing piston (11) can consist of a permanent arrangement, and in the same time with, that the activating vessel (8) has build in an electric-magnet arrangement (10), there by the function can forced the crashing-and higher piston (11) up and down, for lift and in the same time crashing -or striking of the laid garlic (1).
